(19) United States
(12) Patent Application Publication
(10) Pub. No.: US 2013/0325201 A1
(43) Pub. Date: Dec. 5, 2013

(54) SYSTEM AND METHOD FOR CONTROLLING MOVEMENT OF A MEASUREMENT MACHINE

(71) Applicants: HONG FU JIN PRECISION INDUSTRY (SHENZHEN) CO., LTD., Shenzhen (CN); HON HAI PRECISION INDUSTRY CO., LTD., New Taipei (TW)

(72) Inventors: CHIH-KUANG CHANG, New Taipei (TW); HUA-WEI YANG, Shenzhen (CN)

(73) Assignees: HON HAI PRECISION INDUSTRY CO., LTD., New Taipei (TW); HONG FU JIN PRECISION INDUSTRY (ShenZhen) CO., LTD., Shenzhen (CN)

(21) Appl. No.: 13/726,609

(22) Filed: Dec. 25, 2012

(30) Foreign Application Priority Data
May 30, 2012 (CN) 201210171688.0

(51) Int. Cl. G05B 15/02

(52) U.S. Cl. CPC G05B 15/02
USPC 700/302

(57) ABSTRACT

A method for controlling movement of a measurement machine using a computer. The computer sends a movement instruction to the measurement machine and starts a shaft to move according to parameters of the measurement machine. The computer sends a stop instruction to the measurement machine and powers off a signal light of the measurement machine, if the measurement machine works normally and the shaft contacts an object. The computer computes the coordinates of the contact point, if the shaft is not contacted again when the shaft rebounds.

### BACKGROUND

1. Technical Field

Embodiments of the present disclosure relate to movement control systems and methods, and more particularly to a system and method for controlling movement of a measurement machine.

2. Description of Related Art

In the precision measurement field, a measurement machine is widely used to measure outlines of an object. The measurement machine uses a shaft to contact the object and measures a set of plane coordinates of contact points on the object, and generates a curve surface of the object based on the coordinates of the contact points. However, undesired and inaccurate movement of the measurement machine may occur during a measurement of the object.

### BRIEF DESCRIPTION OF THE DRAWINGS

FIG. 1 is a schematic block diagram of one embodiment of a system for controlling movement of a measurement machine.

FIG. 2 is a block diagram of one embodiment of a computer included in FIG. 1.

FIG. 3 is a flowchart of one embodiment of a method for controlling movement of the measurement machine.

### DETAILED DESCRIPTION

The disclosure, including the accompanying drawings, is illustrated by way of example and not by way of limitation. It should be noted that references to “an” or “one” embodiment in this disclosure are not necessarily to the same embodiment, and such references mean “at least one.”

In general, the word “module,” as used herein, refers to logic embodied in hardware or firmware, or to a collection of software instructions, written in a programming language. One or more software instructions in the modules may be embedded in firmware, such as in an erasable programmable read only memory (EPROM). The modules described herein may be implemented as either software and/or hardware modules and may be stored in any type of non-transitory computer-readable medium or other storage device. Some non-limiting examples of non-transitory computer-readable media include CDs, DVDs, BLU-RAY, flash memory, and hard disk drives.

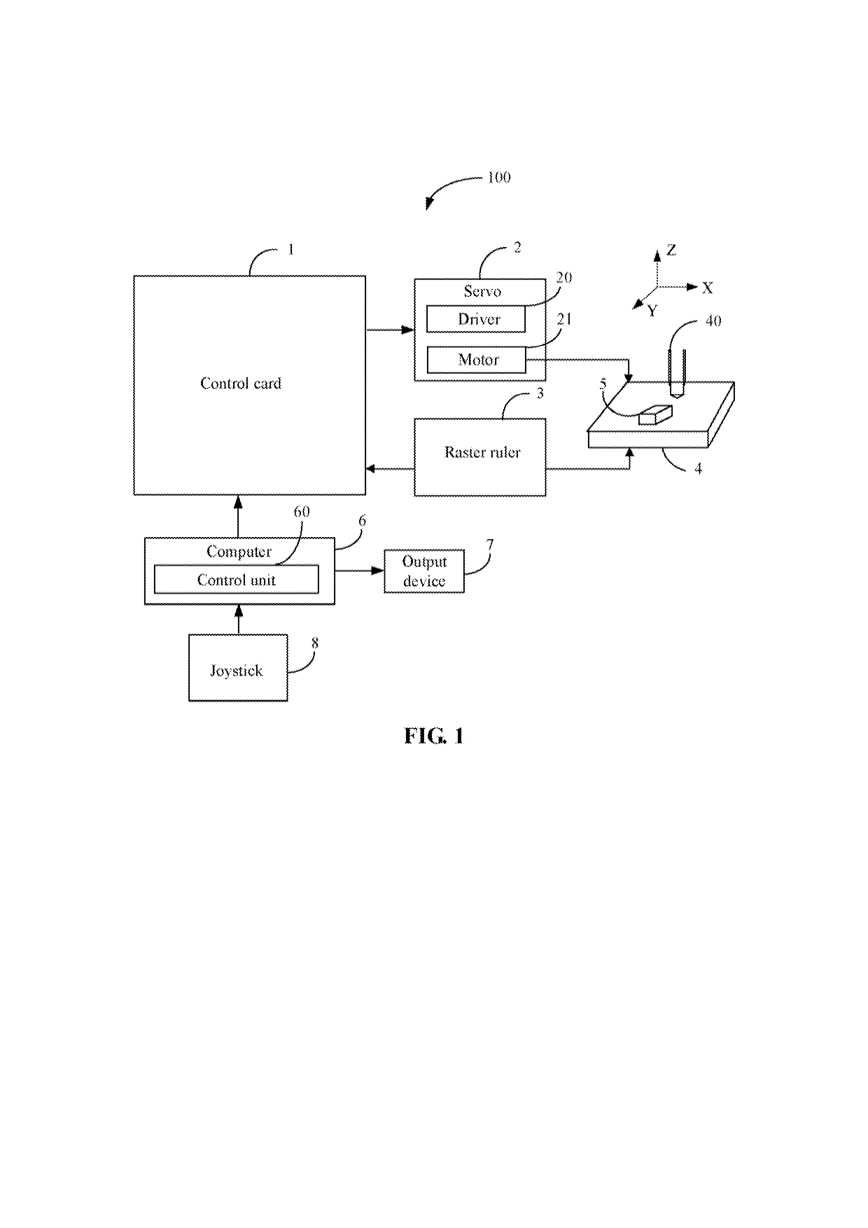

FIG. 1 is a block diagram of one embodiment of a system 100 for controlling movement of a measurement machine 4. The system 100 includes a control card 1, a servo 2, a raster ruler 3, the measurement machine 4, and a computer 6. In one embodiment, the control card 1 is connected to the servo 2, the raster ruler 3 and the computer 6. The servo 2 and the raster 3 are both further connected to the measurement machine 4. The computer 6 is also connected to an output device 7 and a joystick 8.

The servo 2 includes a driver 20 and a motor 21. The driver 20 receives pulse frequency modulation (PFM) signals from the control card 1, and provides a voltage to the motor 21 to start the motor 21. The motor 21 is connected to a shaft 40 of the measurement machine 4, and drive the shaft 40 to move in a certain direction and with a certain speed. The direction and the speed are set by a user in the computer 2. The direction may be, an X-axis direction, a Y-axis direction, or a Z-axis direction as shown in FIG. 1. The shaft 40 may contact an object 5 positioned on a platform of the measurement machine 4 during the movement of the shaft 40. In one embodiment, if the shaft 40 contacts the object 5, the shaft 40 rebounds at a rebound distance (e.g., two centimeters).

The raster ruler 3 is separately fixed on the shaft 40 along the X-axis direction, the Y-axis direction, and the Z-axis direction. The raster ruler 3 further obtains a moving distance of the shaft 40 and coordinates of a contact point when the motions shaft 40 contacts the object 5. In one embodiment, the coordinates of the contact point includes an X-axis value, a Y-axis value, and a Z-axis value. The moving distance of the shaft 40 is calculated as follows: when the shaft 40 moves a predetermined distance (e.g., a lattice distance of the raster ruler 3), the raster ruler 3 sends a signal to the control card 1. The control card 1 calculates the number of signals from the raster ruler 3, and calculates the moving distance of the shaft 40 according to the number of the signals from the raster ruler 3. The moving distance of the shaft 40 is equal to the number of the signals multiplied by the predetermined distance. For example, if the number of the signals is equal to twenty, the lattice distance of the raster ruler 3 is equal to 0.1 millimeter, and the moving distance of the shaft 40 is equal to two millimeter.

The computer 6 is connected to the joystick 8 via a RS-232 port or a universal serial bus (USB) port. The user manually operates the joystick 8 to move the shaft 40. The output device 7 displays the coordinates of the contact point, the moving distance of the shaft 40, and an error code when an error occurs at the measurement machine 4. The error code may be denoted in a format of numbers (e.g., “123”), letters (e.g., “a”) or a combination of numbers and letters (e.g., “a1”). Each error code indicates that the error occurs at the measurement machine 4. For example, the error code “a1” indicates that a limit switch starts when the shaft 40 is moving, the error code “b1” indicates that the shaft 40 contacts the object 5 again or contacts other object when the shaft 40 rebounds. In one embodiment, the output device 7 may be a displaying device.

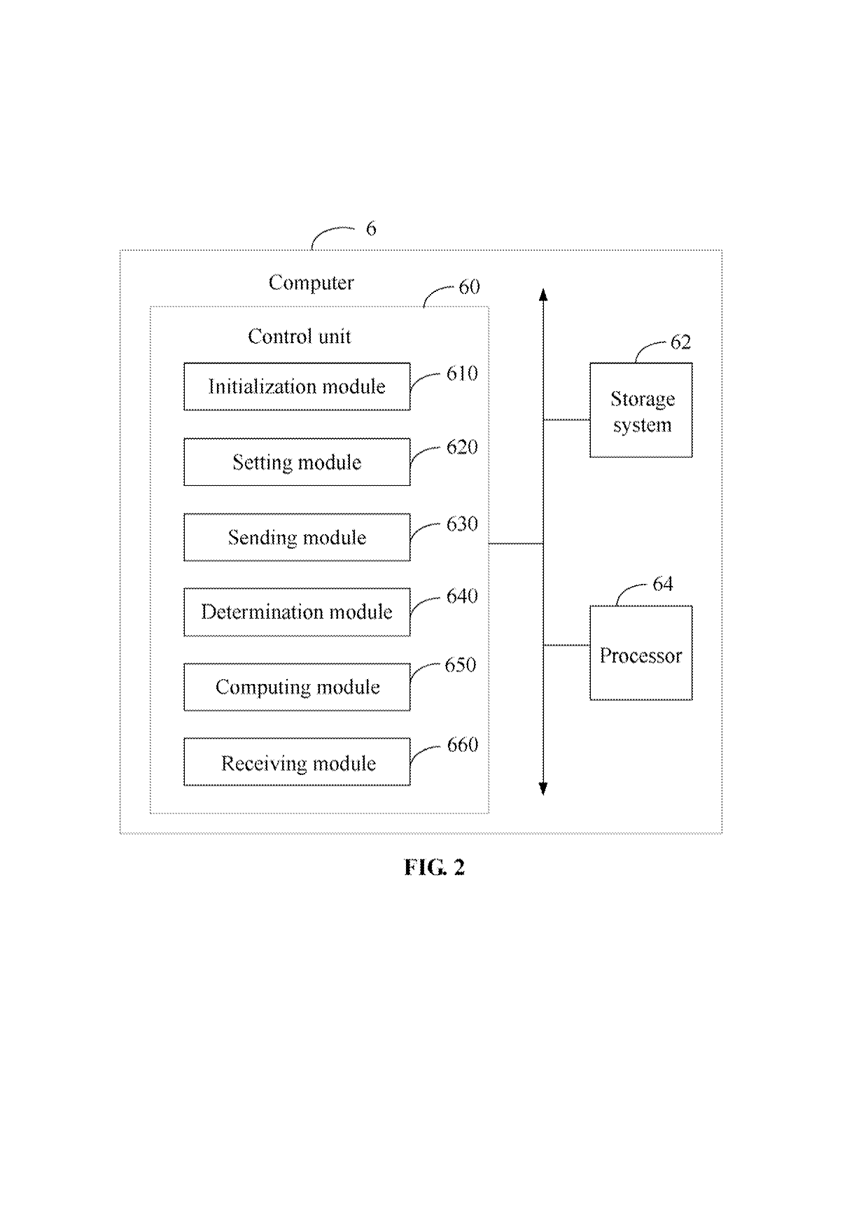

FIG. 2 is a block diagram of one embodiment of the computer 6. The computer 6 includes a control unit 60. The control unit 60 may be used to control the movement of the shaft 40. The computer 6 includes a storage system 62, and at least one processor 64. In one embodiment, the control unit 60 includes an initialization module 610, a setting module 620, a sending module 630, a determination module 640, a computing module 650 and a receiving module 660. The modules 610-660 may include computerized code in the form of one or more programs that are stored in the storage system 62. The computerized code includes instructions that are executed by the at least one processor 64 to provide functions for the modules 610-660. The storage system 62 may be a memory, such as an EPROM, hard disk drive (HDD), or flash memory.

The initialization module 610 initializes the servo 2 and the measurement machine 4 using the control card 1. In one embodiment, the initialization module 610 sends an initialization instruction to the control card 1, so that the control card 1 controls the servo 2 to be initialized, and the servo 2 controls the measurement machine 4 to be initialized according to the initialization instruction. The servo 2 is initialized upon the condition as follows: the servo 2 is in a closed-circle state. The servo 2 is capable of receiving instructions from the control card 1 if the servo 2 is at the closed-circle state. The measurement machine 4 is initialized upon the condition as follows: a limit switch of the measurement machine 4 is at a low voltage level, the shaft 40 does not contact the object 5 or any other objects, the measurement machine 4 includes a mechanical origin, an emergency button of the measurement machine 4 is not pressed.

The setting module 620 sets parameters of the measurement machine 4. The parameters of the measurement machine 4 include a movement of the shaft 40, a speed of the shaft 40, a movement range of the shaft 40, a target position of the object 5 where the shaft 40 is desired to contact, a time to obtain coordinates of a contact point. The contact point is a target position where the shaft 40 contacts the object 5.

The movement of the shaft 40 includes a measurement model, a joystick model, a movement model, and a rebound model. The measurement model is defined that the shaft 40 automatically moves towards the target position of the object 5, and contacts the object 5, and obtains coordinates of the contact point. The joystick model is defined that the shaft 40 moves towards the target position of the object 5 using the joystick 8, and contacts the object 5, and obtains coordinates of the contact point. In other words, the user controls the joystick 8 to move the shaft 40 towards the target position of the object 5. The movement model is defined that the shaft 40 moves and does not contact the object 5. The rebound model is defined that the shaft 40 rebounds the predetermined distance from the contact point if the shaft 40 contacts the object 5.

The time to obtain coordinates of the contact point is defined as a real time when the shaft 40 contacts the object 5. For example, if the shaft 40 contacts the object 5, the coordinates of the contact point is obtained immediately. The time to obtain coordinates of the contact point is also defined as a predetermined time (e.g., 0.2 second) after the shaft 40 contacts the object 5. For example, if the shaft 40 contacts the object 5, the coordinates of the contact point is obtained 0.2 second later.

The sending module 630 sends a movement instruction to the measurement machine 4 and starts the shaft 40 to move according to the parameters of the measurement machine 4.

The determination module 640 determines if the measurement machine 4 works normally during movement of the shaft 40. The measurement machine 4 works normally during movement of the shaft 40 upon the conditions as follow: the shaft 40 moves inside the movement range, and the limit switch of the measurement machine 4 is at the low voltage level. Otherwise, if the shaft 40 moves outside the movement range, or the limit switch of the measurement machine 4 is at a high voltage level, the measurement machine 4 works abnormally.

The determination module 640 further determines if the shaft 40 contacts the object 5. In one embodiment, if the shaft 40 contacts the object 5, then a state of the shaft 40 is changed. For example, the shaft 40 is at the state A, after the shaft 40 contacts the object 5, the shaft 40 changes from the state A to the state B. The determination module determines the shaft 40 contacts the object 5 if the state of the shaft 40 is changed.

The sending module 630 sends a stop instruction to the measurement machine 4 and powers off a signal light of the measurement machine 4. The shaft 40 contacts the object 5 if the signal light is powered off.

The determination 640 determines if the motion shaft 40 again contacts the object 5 when the motion shaft 40 rebounds. If the motion shaft 40 again contact the object 5 the state of the motion shaft 40 is changed again. For example, the motion shaft 40 changes from state B to state A.

The computing module 650 computes the coordinates of the contact point and saves the coordinates of the contact point into the storage system 62. Using the formula: X=P1*S1, Y=P2*S2, Z=P3*S3, wherein X is the X-axis value of the coordinates of the contact point, P1 is the number of the signals from the raster ruler 3 fixed on the X-axis direction, S1 is a resolution of the raster ruler 3 fixed on the X-axis direction, Y is the Y-axis value of the coordinates of the contact point, P2 is the number of the signals from the raster ruler 3 fixed on the Y-axis direction, S2 is a resolution of the raster ruler 3 fixed on the Y-axis direction, Z is the Z-axis value of the coordinates of the contact point, P3 is the number of the signals from the raster ruler 3 fixed on the Y-axis direction, and S3 is a resolution of the raster ruler 3 fixed on the Z-axis direction.

In one embodiment, the computing module 650 uses another formula to compute the coordinates of the contact point. Using the formula: X=(P1−F)/S/(S1*10)/(I*32), Y=(P2−F)/S/(S2*10)/(I*32), Z=(P2−F)/S/(S2*10)/(I*32), wherein X is the X-axis value of the coordinates of the contact point, P1 is the number of the signals from the raster ruler 3 fixed on the X-axis direction, S1 is a resolution of the raster ruler 3 fixed on the X-axis direction, Y is the Y-axis value of the coordinates of the contact point, P2 is the number of the signals from the raster ruler 3 fixed on the Y-axis direction, S2 is a resolution of the raster ruler 3 fixed on the Y-axis direction, Z is the Z-axis value of the coordinates of the contact point, P3 is the number of the signals from the raster ruler 3 fixed on the Y-axis direction, S3 is a resolution of the raster ruler 3 fixed on the Z-axis direction, and F, S and I are constants.

The receiving module 660 receives an error code from the measurement machine 4 if the measurement machine 4 works abnormally or the shaft 40 is contacted again when the shaft 40 rebounds. The error code is displayed on the output device 7.

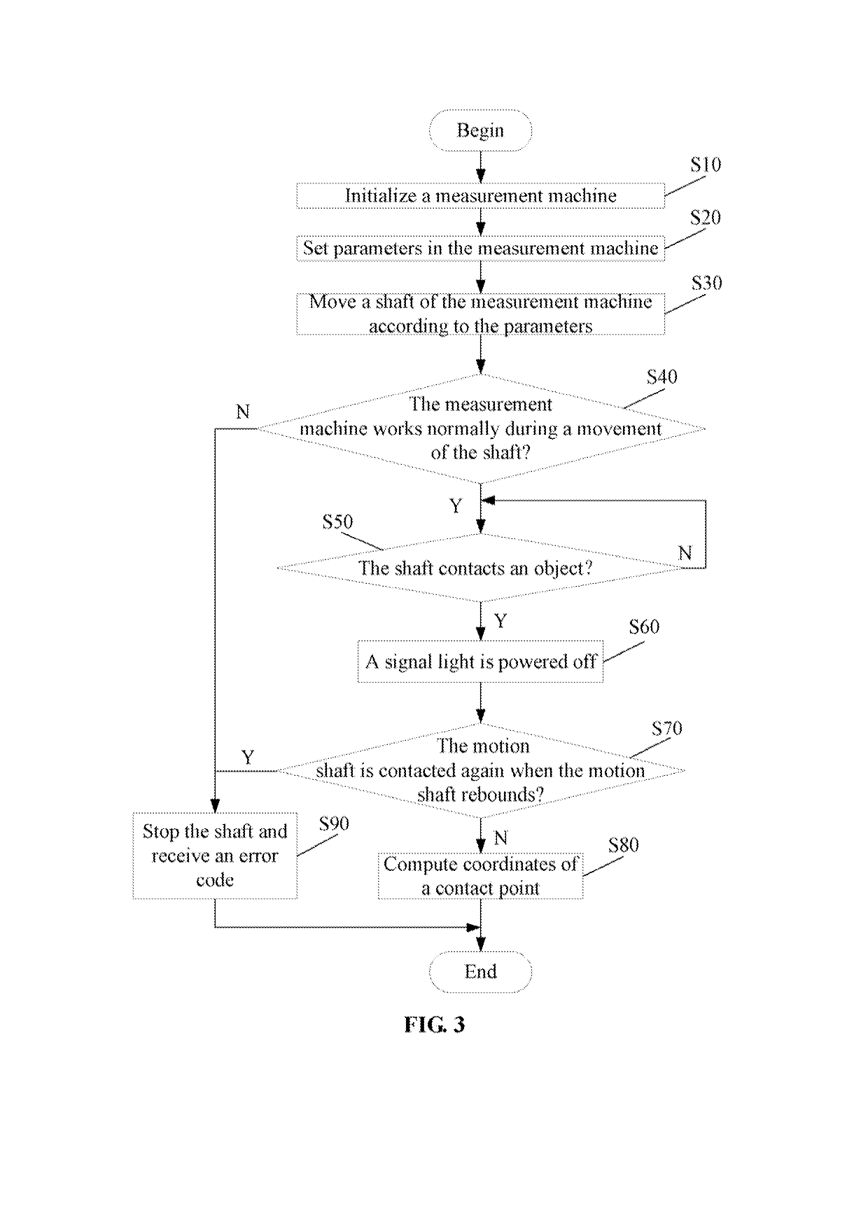

FIG. 3 illustrates a flowchart of one embodiment of a method for controlling movement of a measurement machine. The method can be performed by the execution of a computer-readable program by the at least one processor 14 of the computing device 1. Depending on the embodiment, in FIG. 3, additional steps may be added, others removed, and the ordering of the steps may be changed.

In step S10, the initialization module 610 initializes the servo 2 and the measurement machine 4 using the control card 1. In one embodiment, the initialization module 610 sends an initialization instruction to the control card 1, the control card 1 controls the servo 2 to be initialized, the servo 2 controls the measurement machine 4 to be initialized. The servo 2 is initialized upon the condition as follows: the servo 2 is in a closed-circle state. The servo 2 is capable of receiving instructions from the control card 1 if the servo 2 is at the closed-circle state. The measurement machine 4 is initialized upon the condition as follows: a limit switch of the measurement machine 4 is at a low voltage level, the shaft 40 does not contact the object 5 or any other objects, the measurement machine 4 includes a mechanical origin, an emergency button of the measurement machine 4 is not pressed.

In step S20, the setting module 620 sets parameters of the measurement machine 4. As mentioned above, the parameters of the measurement machine 4 include a movement of the shaft 40, a speed of the shaft 40, a movement range of the shaft 40, a target position of the object 5 where the shaft 40 is desired to contact, a time to obtain coordinates of a contact point. The contact point is a target position where the shaft 40 contacts the object 5.

In step S30, the sending module 630 sends a movement instruction to the measurement machine 4 and starts the shaft 40 to move according to the parameters of the measurement machine 4. For example, if the measurement model is set as the measurement model and the rebound model, the speed of the shaft 40 is set as 0.5 m/s, the time to obtain the coordinates of the contact point is 0.2 second, the shaft 40 move toward the object 5 at the speed of 0.5 m/s, the shaft 40 rebounds after the shaft 40 contacts the object 5, and the coordinates of the contact point is obtained 0.2 second after the shaft 40 contacts the object 5.

In step S40, the determination module 640 determines if the measurement machine 4 works normally during movement of the shaft 40. In one embodiment, if the shaft 40 moves inside the movement range, and the limit switch of the measurement machine 4 is at the low voltage level, the measurement machine 4 works normally, the procedure goes to step 50. Otherwise, if the shaft 40 moves outside the movement range, or the limit switch of the measurement machine 4 is at a high voltage level, the measurement machine 4 works abnormally, the procedure goes to step S90.

In step S50, the determination module 640 further determines if the shaft 40 contacts the object 5. In one embodiment, if the shaft 40 contacts the object 5, the procedure goes to step S60. Otherwise, step S50 is repeated.

In step S60, the sending module 630 sends a stop instruction to the measurement machine 4 and powers off a signal light of the measurement machine 4. The shaft 40 contacts the object 5 if the signal light is powered off. The user visually know that the shaft 40 contacts the object 5 by the signal light.

In step S70, the determination module 640 determines if the shaft 40 is contacted again when the shaft 40 rebounds. In one embodiment, if the shaft 40 is contacted again when the shaft 40 rebounds, the procedure goes to step S90. Otherwise, if the shaft 40 is not contacted again when the shaft 40 rebounds, the procedure goes to step S80.

In step S80, the computing module 650 computes the coordinates of the contact point and saves the coordinates of the contact point into the storage system 62. In one embodiment, the computing module 650 computes the coordinates of the contact point using the formula as mentioned above.

In step S90, the receiving module 660 receives an error code from the measurement machine 4. The error code is displayed on the output device 7. For example, if the limit switch starts when the shaft 40 is moving, the error code “a1” is displayed on the output device 7.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A computer, comprising:
a storage system;
at least one processor; and
one or more programs stored in the storage system and being executable by the at least one processor, the one or more programs comprising:
a setting module sets parameters of a measurement machine;
a sending module sends a movement instruction to the measurement machine and starts a shaft to move according to the parameters of the measurement machine;
a determination module determines whether the measurement machine works normally during movement of the shaft, and determines if the shaft contacts an object;
a sending module sends a stop instruction to the measurement machine and powers off a signal light of the measurement machine, if the measurement machine works normally and the shaft contacts the object;
the determination further determines whether the shaft is contacted again when the shaft rebounds; and
a computing module computes the coordinates of the contact point if the shaft is not contacted again when the shaft rebounds.

2. The computer of claim 1, wherein the parameters of the measurement machine comprises a movement of the shaft, a speed of the shaft, a movement range of the shaft, a target position of the object where the shaft is desired to contact, a time to obtain coordinates of a contact point.

3. The computer of claim 2, wherein the movement of the shaft comprises a measurement model, a joystick model, a movement model, and a rebound model.

4. The computer of claim 1, wherein the measurement machine works normally during movement of the shaft upon the conditions that the shaft moves inside the movement range and a limit switch of the measurement machine is at the low voltage level.

5. The computer of claim 1, wherein the shaft contacts the object upon the condition that a state of the shaft is changed.

6. The computer of claim 1, wherein the coordinates of the contact point is computed as follows: X=P1*S1, Y=P2*S2, Z=P3*S3, wherein X is an X-axis value of the coordinates of the contact point, P1 is the number of the signals obtained from a raster ruler fixed on an X-axis direction of the measurement machine, S1 is a resolution of the raster ruler fixed on the X-axis direction of the measurement machine, Y is a Y-axis value of the coordinates of the contact point, P2 is the number of the signals obtained from the raster ruler fixed on a Y-axis direction of the measurement machine, S2 is a resolution of the raster ruler fixed on the Y-axis direction of the measurement machine, Z is a Z-axis value of the coordinates of the contact point, P3 is the number of the signals obtained from a raster ruler fixed on the Y-axis direction of the measurement machine, and S3 is a resolution of the raster ruler fixed on the Z-axis direction of the measurement machine.

7. A method being executed by a processor of a computer connected to a measurement machine for controlling movement of the measurement machine, the method comprising:
setting parameters of a measurement machine;
sending a movement instruction to the measurement machine and starting the shaft to move according to the parameters of the measurement machine;
determining whether the measurement machine works normally during movement of the shaft, and determining whether the shaft contacts an object;
sending a stop instruction to the measurement machine and powering off a signal light of the measurement machine, if the measurement machine works normally and the shaft contacts the object;
determining whether the shaft is contacted again when the shaft rebounds; and
computing the coordinates of the contact point, if the shaft is not contacted again when the shaft rebounds.

8. The method of claim 7, wherein the parameters of the measurement machine comprises a movement of the shaft, a speed of the shaft, a movement range of the shaft, a target position of the object where the shaft is desired to contact, a time to obtain coordinates of a contact point.

9. The method of claim 8, wherein the movement of the shaft comprises a measurement model, a joystick model, a movement model, and a rebound model.

10. The method of claim 7, wherein the measurement machine works normally during movement of the shaft upon the conditions that the shaft moves inside the movement range and a limit switch of the measurement machine is at the low voltage level.

11. The method of claim 7, wherein the shaft contacts the object upon the condition that a state of the shaft is changed.

12. The method of claim 7, wherein the coordinates of the contact point is computed as follows: X=P1*S1, Y=P2*S2, Z=P3*S3, wherein X is an X-axis value of the coordinates of the contact point, P1 is the number of the signals obtained from a raster ruler fixed on an X-axis direction of the measurement machine, S1 is a resolution of the raster ruler fixed on the X-axis direction of the measurement machine, Y is a Y-axis value of the coordinates of the contact point, P2 is the number of the signals obtained from the raster ruler fixed on a Y-axis direction of the measurement machine, S2 is a resolution of the raster ruler fixed on the Y-axis direction of the measurement machine, Z is a Z-axis value of the coordinates of the contact point, P3 is the number of the signals obtained from a raster ruler fixed on the Y-axis direction of the measurement machine, and S3 is a resolution of the raster ruler fixed on the Z-axis direction of the measurement machine.

13. A non-transitory computer-readable medium having stored therein instructions that, when executed by a computer, cause the computer to perform a method for controlling movement of a measurement machine connected to the computer, the method comprising:
setting parameters of a measurement machine;
sending a movement instruction to the measurement machine and starting the shaft to move according to the parameters of the measurement machine;
determining whether the measurement machine works normally during movement of the shaft, and determining whether the shaft contacts an object;
sending a stop instruction to the measurement machine and powering off a signal light of the measurement machine, if the measurement machine works normally and the shaft contacts the object;
determining whether the shaft is contacted again when the shaft rebounds; and
computing the coordinates of the contact point, if the shaft is not contacted again when the shaft rebounds.

14. The non-transitory medium of claim 13, wherein the parameters of the measurement machine comprises a movement of the shaft, a speed of the shaft, a movement range of the shaft, a target position of the object where the shaft is desired to contact, a time to obtain coordinates of a contact point.

15. The non-transitory medium of claim 14, wherein the movement of the shaft comprises a measurement model, a joystick model, a movement model, and a rebound model.

16. The non-transitory medium of claim 13, wherein the measurement machine works normally during movement of the shaft upon the conditions that the shaft moves inside the movement range and a limit switch of the measurement machine is at the low voltage level.

17. The non-transitory medium of claim 13, wherein the shaft contacts the object upon the condition that a state of the shaft is changed.

18. The non-transitory method of claim 13, wherein the coordinates of the contact point is computed as follows: X=P1*S1, Y=P2*S2, Z=P3*S3, wherein X is an X-axis value of the coordinates of the contact point, P1 is the number of the signals obtained from a raster ruler fixed on an X-axis direction of the measurement machine, S1 is a resolution of the raster ruler fixed on the X-axis direction of the measurement machine, Y is a Y-axis value of the coordinates of the contact point, P2 is the number of the signals obtained from the raster ruler fixed on a Y-axis direction of the measurement machine, S2 is a resolution of the raster ruler fixed on the Y-axis direction of the measurement machine, Z is a Z-axis value of the coordinates of the contact point, P3 is the number of the signals obtained from a raster ruler fixed on the Y-axis direction of the measurement machine, and S3 is a resolution of the raster ruler fixed on the Z-axis direction of the measurement machine.
